(19) United States
(12) Patent Application Publication
(10) Pub. No.: US 2023/0422071 A1
(43) Pub. Date: Dec. 28, 2023

(54) METHOD AND NODES FOR HANDLING BEAM MEASUREMENTS

(71) Applicant: Telefonaktiebolaget LM Ericsson (publ), Stockholm (SE)

(72) Inventors: Pradeepa RAMACHANDRA, Linköping (SE); Angelo CENTONZA, Granada (ES); Panagiotis SALTSIDIS, Stockholm (SE)

(21) Appl. No.: 18/249,433

(22) PCT Filed: Oct. 20, 2021
(86) PCT No.: PCT/SE2021/051032

§ 371 Date: Apr. 18, 2023

Related U.S. Application Data
(60) Provisional application No. 63/094,967, filed on Oct. 22, 2020.

(51) Int. Cl. H04W 24/10; H04W 24/08

(52) U.S. Cl. CPC H04W 24/10; H04W 24/08

(57) ABSTRACT

The present disclosure relates to a method performed by a network node for handling of one or more beam measurements in a communications system. The network node obtains information associated with a report configuration for one or more beam measurements from another node. Based on the obtained information, the network node provides, to a UE, instructions on how to provide a report of the one or more beam measurements to the network node. The network node obtains, from the UE and according to the instructions, the report of the one or more beam measurement, wherein the report includes information associated with executed one or more beam measurements.

### TECHNICAL FIELD

The present disclosure relates generally a network node, a method performed by the network node, another node and a method performed by the other node. More particularly, the present disclosure relates to handling or enabling beam measurements. The present disclosure relates to a beam related configuration for UE measurement collection.

### BACKGROUND

Immediate Minimization of Drive Tests (MDT)

Immediate MDT is standardized so that the management systems can collect the Key Performance Indicators (KPI) associated to a UE in the connected mode. Immediate MDT is described in 3GPP TS 37.320 V16.2.0 (2020-09) as an “MDT functionality involving measurements performed by the UE in CONNECTED state and reporting of the measurements to RAN available at the time of reporting condition as well as measurements by the network for MDT purposes.” The following excerpts from TS 37.320 (V16.1.0) provide some configuration and reporting of measurements in immediate MDT.

Immediate MDT Procedures

Measurement Configuration

For Immediate MDT, Radio Access Network (RAN) measurements and UE measurements can be configured. The configuration for UE measurements is based on the existing Radio Resource Control (RRC) measurement procedures for configuration and reporting with some extensions for location information.

No extensions related to time stamp are expected for Immediate MDT i.e. time stamp is expected to be provided by the evolvedNodeB/Radio Network Controller/gNodeB (eNB/RNC/gNB).

If area scope is included in the MDT configuration provided to the RAN, the UE is configured with a respective measurement when the UE is connected to a cell that is part of the configured area scope.

Measurement Reporting

For Immediate MDT, the UE provides detailed location information, e.g. Global Navigation Satellite Systems (GNSS) location information, if available. The UE also provides available neighbor cell measurement information that may be used to determine the UE location, Radio Frequency (RF) fingerprint. E-UTRAN Cell Global Identifier (ECGI), Cell-Id, or Cell Identity of the serving cell when the measurement was taken is always assumed known in E-UTRAN, UTRAN or NR respectively. E-UTRAN is short for Evolved UMTS Terrestrial Radio Access Network, UMTS is short for Universal Mobile Telecommunications System, UTRAN is short for UMTS Terrestrial Radio Access Network and NR is short for New Radio.

The location information which comes with UE radio measurements for MDT can be correlated with other MDT measurements, e.g. RAN measurements. For MDT measurements where UE location information is provided separately, it is assumed that the correlation of location information and MDT measurements should be done in the TCE based on timestamps.

RRC_CONNECTED

In RRC_CONNECTED state, the UE supports Immediate MDT. In order to support Immediate MDT, the existing RRC measurement configuration and reporting procedures apply. Some extensions are used to carry location information.

Measurements and Reporting Triggers for Immediate MDT

Measurements to be performed for Immediate MDT purposes involve reporting triggers and criteria utilized for Radio Resource Management (RRM). In addition, there are associated network performance measurements performed in the gNB.

In particular, the following measurements shall be supported for Immediate MDT performance:

Measurements:
M1: Downlink (DL) signal quantities measurement results for the serving cell and for intra-frequency/Inter-frequency/inter-Radio Access Technology (RAT) neighbor cells, including cell/beam level measurement for NR cells only.
M2: Power Headroom measurement by UE.
M3: Received Interference Power measurement. Not applicable for NR.
M4: Data Volume measurement separately for DL and Uplink (UL), per Data Radio Bearers (DRB) per UE
M5: Average UE throughout measurement separately for DL and UL, per DRB per UE and per UE for the DL, per DRB per UE and per UE for the UL, by gNB,
M6: Packet Delay measurement separately for DL and UL, per DRB per UE.
M7: Packet loss rate measurement separately for DL and UL, per DRB per UE.
M8: Received Signal Strength Indicator (RSSI) measurement by UE, e.g. for WLAN/Bluetooth measurement. WLAN is short for Wireless Local Area Network.
M9: Round Trip Time (RTT) Measurement by UE, e.g. for WLAN measurement.

Measurement collection triggers:
For M1:
   Event-triggered measurement reports according to existing RRM configuration for events A1, A2, A3, A4, A5, A6, B1 or B2
   Periodic, A2 event-triggered, or A2 event triggered periodic measurement report according to MDT specific measurement configuration.
For M2:
   Reception of Power Headroom Report (PHR) according to existing RRM configuration.

Note that PHR is carried by Medium Access Control (MAC) signaling. Thus, the existing mechanism of PHR transmission applies.
For M3:
   End of measurement collection period.
For M4:
   End of measurement collection period.
For M5:
   End of measurement collection period.
For M6:
   End of measurement collection period.
For M7:
   End of measurement collection period.
For M8:
   End of measurement collection period.
For M9:
   End of measurement collection period.

Measurement Configuration

A UE can be configured with at most one measObject on a given frequency. The following excerpts from TS 38.331 (V16.1.0) provide some details on the measurement configuration.

General

The network applies the procedure as follows:
to ensure that, whenever the UE has a measurement Configuration (measConfig) associated with a Cell Group (CG), it includes a measurement Object (measObject) for the Special Cell (SpCell) and for each NR SCell of the CG to be measured;
to configure at most one measurement identity across all CGs using a reporting configuration with the reportType set to reportCGI;
to configure at most one measurement identity per CG using a reporting configuration with the ul-DelayValueConfig;
to ensure that, in the measConfig associated with a CG:
for all Synchronization Signal Block (SSB) based measurements there is at most one measurement object with the same ssbFrequency;

| | |
|---|---|
| MeasObjectNR | SEQUENCE |

| | |
|---|---|
| ssbFrequency | ARFCN-ValueNR |
| OPTIONAL, -- Cond SSBorAssociatedSSB | |
| ssbSubcarrierSpacing | SubcarrierSpacing |
| OPTIONAL, -- Cond SSBorAssociatedSSB | |
| smtc1 | SSB-MTC |
| OPTIONAL, -- Cond SSBorAssociatedSSB | |
| smtc2 | SSB-MTC2 |
| OPTIONAL, -- Cond IntraFreqConnected | |
| refFreqCSI-RS | ARFCN-ValueNR |
| OPTIONAL, -- Cond CSI-RS | |
| referenceSignalConfig | ReferenceSignalConfig, |
| absThreshSS-BlocksConsolidation | ThresholdNR |
| OPTIONAL, -- Need R | |
| absThreshCSI-RS-Consolidation | ThresholdNR |
| OPTIONAL, -- Need R | |
| nrofSS-BlocksToAverage | INTEGER (2 . . maxNrofSS-BlocksToAverage) |
| OPTIONAL, -- Need R | |
| nrofCSI-RS-ResourcesToAverage | INTEGER (2 . . maxNrofCSI-RS-ResourcesToAverage) |
| OPTIONAL, -- Need R | |
| quantityConfigIndex | INTEGER (1 . . maxNrofQuantityConfig), |
| offsetMO | Q-OffsetRangeList, |
| cellsToRemoveList | PCI-List |
| OPTIONAL, -- Need N | |
| cellstoAddModList | cellsToAddModList |
| OPTIONAL, -- Need N | |
| blackcellsToRemoveList | PCI-RangeIndexList |
| OPTIONAL, -- Need N | |
| blackCellsToAddModList | SEQUENCE (SIZE (1 . . maxNrofPCI-Ranges ) ) OF PCI- |
| RangeElement OPTIONAL, -- Need N | |
| whiteCellsToRemoveList | PCI-RangeIndexList |
| OPTIONAL, -- Need N | |
| whiteCellsToAddModList | SEQUENCE (SIZE (1 . . maxNrofPCI-Ranges ) ) OF PCI- |
| RangeElement OPTIONAL, -- Need N | |
| . . . , | |
| [ [ | |
| freqBandIndicatorNR | FreqBandIndicatorNR |
| OPTIONAL, -- Need R | |
| measCycleSCell | ENUMERATED (sf160, sf256, sf320, sf512, sf640, |
| sf1024, sf1280} OPTIONAL -- Need R | |
| ] ], | |
| [ [ | |
| smtc31ist-r16 | SSB-MTC3List-r16 |
| OPTIONAL, -- Need R | |
| rmtc-Config-r16 | SetupRelease (RMTC-Config-r16] |
| OPTIONAL, -- Need M | |
| t312-r16 | SetupRelease { T312-r16 } |
| OPTIONAL -- Need M | |
| ] ] | |
| } | |

Measurement Reporting

The ReportConfigNR information element (IE) may be as follows:

| | |
|---|---|
| ReportConfigNR : : = | SEQUENCE |
| reportType | CHOICE { |
| periodical | PeriodicalReportConfig, |
| eventTriggered | EventTriggerConfig, |
| . . . , | |
| /*text omitted*/ | |
| } | |
| } | |
| /*text omitted*/ | |
| EventTriggerConfig : : = | SEQUENCE { |
| eventId | CHOICE { |
| /*text omitted*/ | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| /*text omitted*/ | |
| }, | |
| rsType | NR-RS-Type, |
| reportInterval | ReportInterval, |
| reportAmount | ENUMERATED {r1, r2, r4, r8, r16, r32, r64, |
| infinity}, | |
| reportQuantityCell | MeasReportQuantity, |
| maxReportCells | INTEGER (1 . . maxCellReport), |
| reportQuantityRS-Indexes | MeasReportQuantity |
| OPTIONAL, -- Need R | |
| maxNrofRS-IndexesToReport | INTEGER (1 . . maxNrofIndexesToReport) |
| OPTIONAL, -- Need R | |
| includeBeamMeasurements | BOOLEAN, |
| reportAddNeighMeas | ENUMERATED {setup} |
| OPTIONAL, -- Need R | |
| . . . , | |
| [ [ | |
| measRSSI-ReportConfig-r16 | MeasRSSI-Reportconfig-r16 |
| OPTIONAL, -- Need R | |
| useT312-r16 | BOOLEAN |
| OPTIONAL, -- Need M | |
| includeCommonLocationInfo-r16 | ENUMERATED {true} |
| OPTIONAL, -- Need R | |
| includeBT-Meas r16 | SetupRelease {BT-NameList-r16} |
| OPTIONAL, -- Need M | |
| includeWLAN-Meas-r16 | SetupRelease {WLAN-NameList r16} |
| OPTIONAL, -- Need M | |
| includeSensor-Meas-r16 | SetupRelease {Sensor-NameList-r16} |
| OPTIONAL -- Need M | |
| ] ] | |
| } | |

Without the beam level measurement reporting the OAM node or OAM function would be limited in its capabilities to build the coverage maps at the beam level and would be unable to understand the Quality of Service (QoS) performance analysis at beam level.

It has been previously proposed to add the beam related configurations, including TS type, number of beams to average, the absolute threshold for the consolidation of measurement results, in the M1 configuration for immediate MDT.

An issue with the previous proposal is that the proposed method is focused on how to configure additional such measurements. In order to support the proposed changes, there would be a rather considerable change at the UE side, i.e. that multiple MeasObject per frequency can be configured at the UE.

Therefore, the previously proposed solution requires too big of an impact to resolve the issue of beam level measurement exposure for MDT. At the same time the problem of lack of visibility of beam specific measurements for MDT remains.

Therefore, there is a need to at least mitigate or solve this issue.

### SUMMARY

An objective is to obviate at least one of the above disadvantages and to provide improved handling of beam measurements, or improved handling of beam related configurations.

According to a first aspect, the object is achieved by a method performed by a network node for handling of one or more beam measurement in a communications system. The network node obtains information associated with a report configuration for one or more beam measurements from another node. Based on the obtained information, the network node provides, to a UE, instructions on how to provide a report of the one or more beam measurements to the network node. The network node obtains, from the UE and according to the instructions, the report of the one or more beam measurement. The report comprises information associated with executed one or more beam measurements.

According to a second aspect, the object is achieved by a network node for handling one or more beam measurements in a communications system. The network node is adapted to perform a method according to the first aspect.

According to a third aspect, the object is achieved by a method performed by a node for handling one or more beam measurements in a communications system. The node provides information associated with a report configuration for one or more beam measurements to a network node.

According to a fourth aspect, the object is achieved by node for handling one or more beam measurements in a communications system. The node is adapted to perform a method according to the third aspect.

The present disclosure herein affords many advantages, of which a non-exhaustive list of examples follows:

An advantage of the present disclosure is that it enables reporting of the criteria according to which beam measurement reporting is carried out, i.e. instruction on how to provide a report of the one or more beam measurements.

Another advantage of the present disclosure is to enable the node, e.g. the OAM, to have control over the collection of beam(s′) measurements and thus enabling building up of coverage maps associated to the beam(s).

Yet another advantage of the present disclosure is that the beam level coverage map production is based on report configuration of existing RRM measurements without requiring additional measurements.

The present disclosure starts from the assumption that a MeasObject has already provided to the UE the beam measurement configuration, e.g. cell quality derivation parameters. In general, this is the assumption for M1 measurements, i.e. the M1 measurement configuration is not provided by OAM via MDT Configuration but it is provided by the RAN. According to the current specifications, the M1 configuration sent from the OAM only addresses the reportConfig related parameters, and not the measObject parts.

An advantage of the present disclosure is that does not imply any changes at specification level concerning the RRC protocol used to configure the UE with measurement reports, as the only addition is for UE to report as part of MDT measurements also the beam measurements and for the RAN or the UE to report the cell quality derivation parameters

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic diagram illustrating a communication system.

FIG. 2 is a signaling diagram illustrating a method.

FIG. 3 is a flow chart illustrating a method performed by a network node.

FIG. 4 is a flow chart illustrating a method performed by an OAM.

FIG. 5a is a schematic drawing illustrating a network node.

FIG. 5b is a schematic drawing illustrating a network node.

FIG. 6 is a schematic block diagram illustrating a telecommunication network connected via an intermediate network to a host computer.

FIG. 7 is a schematic block diagram of a host computer communicating via a base station with a UE over a partially wireless connection.

FIG. 8 is a flowchart depicting a method in a communications system comprising a host computer, a base station and a UE.

FIG. 9 is a flowchart depicting a method in a communications system comprising a host computer, a base station and a UE.

FIG. 10 is a flowchart depicting a method in a communications system comprising a host computer, a base station and a UE.

FIG. 11 is a flowchart depicting a method in a communications system comprising a host computer, a base station and a UE.

The drawings are not necessarily to scale, and the dimensions of certain features may have been exaggerated for the sake of clarity. Emphasis is instead placed upon illustrating the principle.

### DETAILED DESCRIPTION

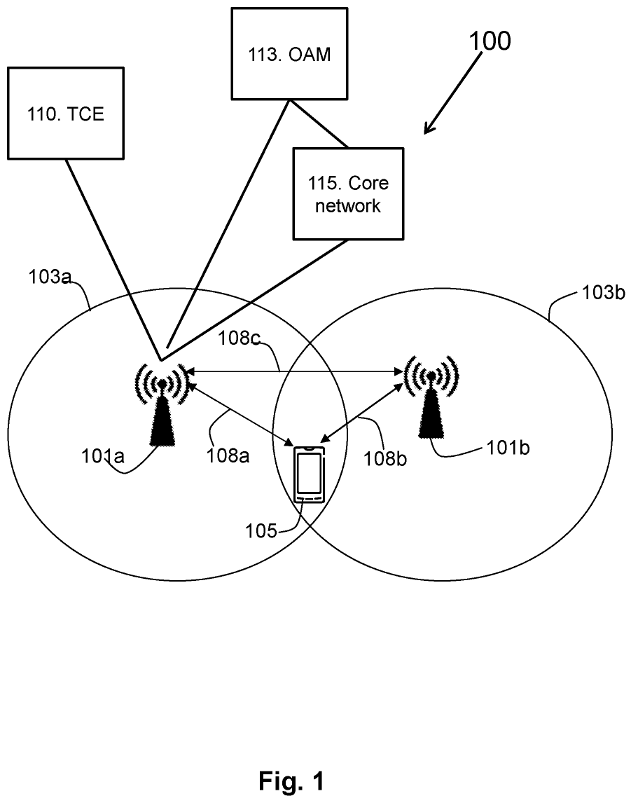

FIG. 1 depicts a non-limiting example of a communications system 100, which may be a wireless communications system, sometimes also referred to as a wireless communications network, cellular radio system, or cellular network, in which the present disclosure may be implemented. The communications system 100 may be a 5G system, network, NR-U or Next Gen system or network. The communications system 100 may alternatively be a younger system or older system than a 5G system, such as e.g. a 2G system, a 3G system, a 4G system, a 6G system a 7G system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in the non-limiting example of FIG. 1. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas, wherein each cell area may be served by a network node, although, one network node may serve one or several cells. In FIG. 1, the communications system 100 comprises a first cell 103a and a second cell 103b. Note that two cells are exemplified in FIG. 1 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 1, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 1 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e. it refers to any of the first cell 103a or second cell 103b.

One or a plurality of UEs 105 is comprised in the communication system 100. Only one UE 105 is exemplified in FIG. 1 for the sake of simplicity. A UE 105 may also be referred to simply as a device. The UE 105, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC).The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g. between two UEs 105, between a UE 105 and a regular telephone, between the UE 105 and a network node, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

The communications system 100 comprises a TCE 110. The TCE 110 is adapted to be connected to and to communicate with a network node 101, e.g. the first network node 101a and/or the second network node 101b. The TCE 110 is adapted to comprise trace records, trace information etc. The TCE 110 may be referred to as a collecting node, an information obtaining node, a third node etc.

The communications system 100 comprises an OAM node 113. The OAM node 113 may be a node implementing an OAM function. The OAM node 113 is adapted to be connected to and to communicate with a network node 101, e.g. the first network node 101a and/or the second network node 101b. The OAM node 113 may be adapted to connect to and to communicate with the network node 101 via one or more core network nodes 115. The OAM node 113 may be referred to as a third node, an operations node 113, a management node 113 etc. The term node together with the reference numbers 113 and 115 will be used herein when referring to any of the OAM 113 or the core network node 115.

It should be noted that the communication links 108 in the communications system 100 may be of any suitable kind comprising either a wired or wireless link. The link may use any suitable protocol depending on type and level of layer, e.g. as indicated by the Open Systems Interconnection (OSI) model, as understood by the person skilled in the art.

In the present disclosure, it may be assumed that a MeasObject has already provided to the UE 105 with the beam measurement configuration, e.g. cell quality derivation parameters. This may be the assumption for M1 measurements, i.e. the M1 measurement configuration may not be provided by the OAM 113 via MDT Configuration but it is provided by the network node 101.

The present disclosure may not imply any changes on how the UE 105 is configured or how it executes measurements, as the only change related to the UE 105 is for the UE to also report the beam measurements report as part of MDT measurements.

According to the current RAN specifications, the M1 configuration sent from the OAM 113 only addresses the reportConfig related parameters, and not the measObject parts.

The present disclosure enables reporting of the criteria according to which beam measurement reporting is carried out. This method is in line with existing RAN specifications and enhances it by enabling the network node 101 to append the cell quality derivation parameters as configured to the UE 105 in the M1 report sent to the TCE 110.

Using updated M1 reporting configuration methods that enable beam measurement reporting the following cell quality derivation method is suggested:

Step 1) The node 113, 115, e.g. the OAM 113, configures M1 report, including reporting of beam level measurements previously configured by the network node 101.

Step 2) The network node 101 provides, e.g. transmits or forwards, the related reportConfig parameters to the UE 105.

Step 3) The network node 101 obtains, e.g. receives, the measurement report from the UE 105, which comprises the M1 measurements comprising the beam level measurements.

Step 4) The network node 101 appends the cell quality derivation parameters, e.g. absThreshSS-BlocksConsolidation and nrofSS-BlocksToAverage, to the report. This allows the node receiving the MDT report, e.g. the TCE 110, to deduce the configuration parameters according to which the beam level measurements were derived. The UE 105 may include these parameters, as configured by the network node 101.

Step 5) The network node 101 sends the M1 report to the TCE 110.

The term cell quality derivation parameters may be used to indicate the set of parameters to which the UE 105 is configured to derive specific cell and beam measurements used for the Derivation of cell measurement results. For example, if the UE 105 is configured to report measurements when an SSB RS is above a certain threshold, the threshold value is a cell quality derivation parameter. Likewise, if the measurement needs to be the result of averaging of different instances of a given RS, the instructions on how to average, e.g. how many RS instances to take into account, constitute cell quality parameters derivation.

The present disclosure enables the beam measurement reporting in a way that is in line with existing RAN specifications while enhancing by providing a method enabling the network node 101 to append the cell quality derivation parameters, as configured to the UE 105, as part of the M1 report sent to the TCE 110.

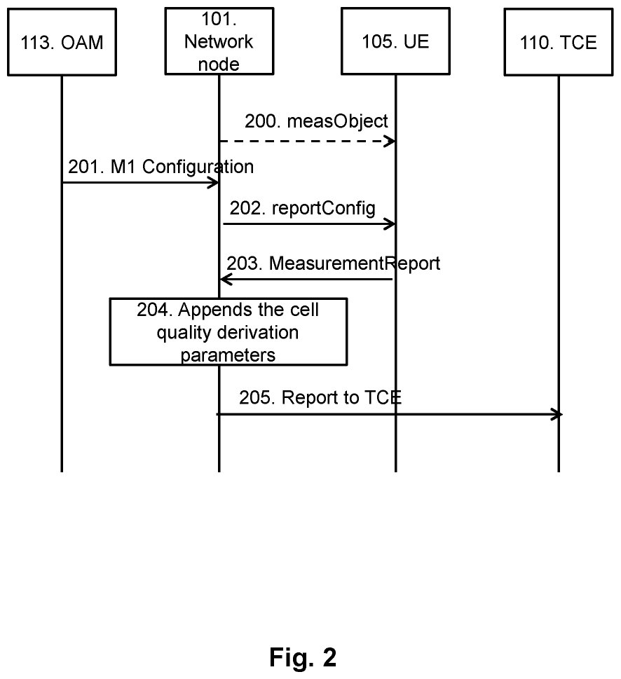

FIG. 2 illustrates a method. Using updated M1 reporting configuration methods that enable beam measurement reporting the cell quality derivation in FIG. 2 may be executed. FIG. 2 illustrates the network node 101, the UE 105, the OAM 113 and the TCE 110. The OAM 113 is illustrated as an example of a node 113, 115 and may be a core network node 115 instead of the OAM 113. The method comprises at least one of the following steps, which steps may be performed in any suitable order than described below:

Step 200

The network node 101, e.g. a RAN node, may configure beam level measurements at the UE 105 by means of a specific set of cell quality derivations. This step may involve that the network node 101 may provide a measObject to the UE 105. Step 200 may be described as the network node 101 may provide, to the UE 105, information associated with configuration of the one or more beam measurement.

The MeasObject enables configuration of the absThreshSS-BlocksConsolidation, nrofSS-BlocksToAverage duration for the SSB, and absThreshCSI-RS-Consolidation, nrofCSI-RS-ResourcesToAverage for the CSI-RS which are used for the derivation of cell based measurement results. The MeasObject is configured independently by the network node 101 and according to specifications that a UE 105 can be configured with at most one measObject on a given frequency.

Step 201

The OAM 113 may configure a M1 report by providing, to the network node 101, MDT configuration instructions. It should be noted that the case where the OAM 113 configures the MDT configuration corresponds to the management-based MDT configuration. The network node 101 may receive an MDT Configuration also from the core network 115, e.g. from the AMF. In this case the MDT configuration may be “signaling based” and the network node 101 may receive the M1 configuration parameters from the core network 115. Step 201 may be described as the network node 101 obtains, information associated with a report configuration for one or more beam measurements from another node 113, 115. The other node may be an OAM 113 or a core network node 115.

The M1 report configuration is exemplified below in Table 1, Table 2 and Table 3. See in particular rows 13-20 in Table 1, the bottom row in Table 2 and the complete Table 3 are addition to the M1 report configuration compared to the previous M1 report configuration.

M1 Configuration IE

This IE defines the parameters for M1 measurement collection.

TABLE 1

| | | | | |
|---|---|---|---|---|
| IE/Group Name | Presence | Range | IE type and reference | Semantics description |

| | | | |
|---|---|---|---|
| M1 Reporting Trigger | M | ENUMERATED | |
| | | (periodic, A2event- | |
| | | triggered, A2event- | |
| | | triggered periodic, . . .) | |
| M1 Threshold Event A2 | C- | | Included in case of event-triggered |
| | ifM1A2trigger | | or event-triggered periodic |
| | | | reporting for measurement M1. |
| >CHOICE Threshold | M | | |
| >>RSRP | | | |
| >>>Threshold RSRP | M | INTEGER (0 . . . 127) | |
| >>RSRQ | | | |
| >>>Threshold RSRQ | M | INTEGER (0 . . . 127) | |
| >>SINR | | | |
| >>>Threshold SINR | M | INTEGER (0 . . . 127) | |
| M1 Periodic reporting | C- | | Included in case of periodic or |
| | ifperiodicMDT | | event-triggered periodic reporting |
| | | | for measurement M1. |
| >Report interval | M | ENUMERATED | |
| | | (ms120, ms240, | |
| | | ms480, ms640, | |
| | | ms1024, ms2048, | |
| | | ms5120, ms10240, | |
| | | min1, min6, min12, | |
| | | min30, min60) | |
| >Report amount | M | ENUMERATED (1, 2, 4, | Number of reports. |
| | | 8, 16, 32, 64, infinity) | |
| Include Beam Measurements | M | ENUMERATED (true, | To configure whether the UE should |
| Indication | | . . .) | include the beam level |
| | | | measurements. |
| Beam Measurements | C- | | Included in case of include the beam |
| configuration | ifM1BeamMeasInd | | level measurements indication for |
| | | | measurement M1. |
| rsType | O | ENUMERATED | This IE configures the RS type of the |
| | | (SSB, CSI-RS) | reported measurements. |
| >M1 reportQuantityRS- | O | | This IE indicates which |
| Indexes | | | measurement information per RS |
| | | | index the UE shall include in the |
| | | | measurement report. |
| >>RSRP | M | ENUMARATED (true, | |
| | | . . .) | |
| >>RSRQ | M | ENUMARATED (true, | |
| | | . . .) | |
| >>SINR | M | ENUMARATED (true, | |
| | | . . .) | |
| >M1 maxNrofRS- | O | INTEGER | Indicates how many beam related |
| IndexesToReport | | (1 . . . maxNrofIndexesTo | measurements are to be included. |
| | | Report) | |

TABLE 2

| Condition | Explanation |
|---|---|
| C-ifM1A2trigger | This IE shall be present if the Measurements to Activate IE has the first bit set to |
| | “1” and the M1 Reporting Trigger IE is set to “A2event-triggered” or to “A2event- |
| | triggered periodic”. |
| C-ifperiodicMDT | This IE shall be present if the M1 Reporting Trigger IE is set to “periodic”, or to |
| | “A2event-triggered periodic”. |
| C- ifM1BeamMeasInd | This IE shall be present if the Include Beam Measurements Indication IE is set to |
| | “true”. |

TABLE 3

| Range bound | Explanation |
|---|---|
| maxNrofIndexesToReport | Maximum no. Max number of beam related measurements to To Report. |
| | Value is 32. |

The underlined text in the three figs. above indicate additions to the report configuration that are added with the present disclosure and are added to the known configuration. The underlined text is found in the last 8 rows in table 1 (counting from the bottom), the last row in table 2 and the whole content of table 3.

Step 202

The network node 101 may provide, e.g. forward, the related reportConfig parameters to the UE 105, where instructions on how to report the M1 measurements are provided.

Using other words, based on the obtained information from step 202, the network node 101 provides, to a UE 105, instructions on how to provide a report of the one or more beam measurements to the network node 101.

Step 203

The network node 101 may obtain, e.g. receives, the measurement report from the UE 105, i.e. it obtains a report of measurements configured by means of the M1 configuration.

Using other words, the network node 101 obtains, from the UE 105 and according to the instructions, the report of the one or more beam measurement. The report comprises information associated with executed one or more beam measurements.

Step 204

The network node 101 may append the cell quality derivation parameters, e.g. absThreshSS-BlocksConsolidation and nrofSS-BlocksToAverage to the report.

Further, the network node 101 may append the cell quality derivation parameters based on the rsType configured in the M1 configuration. If the M1 configuration includes rsType set to SSB, then the network node 101 may include the corresponding absThreshSS-BlocksConsolidation and nrofSS-BlocksToAverage as configured to the UE 105. If the M1 configuration includes rsType set to CSI-RS, then the network node 1010 may include the corresponding absThreshCSI-RSConsolidation and nrofCSI-RSToAverage as configured to the UE 105.

The UE 105 may include these parameters, as configured by the network node 101. Then, the M1 configuration may comprise an indication of cell quality derivation parameters reporting together with the aforementioned indication of beam level measurement reporting. The UE 105, when constructing the M1 measurement report, may include in it the beam level measurements (as in described above) and it may also comprise the cell quality derivation parameters used to derive beam level measurements

Step 205

The network node 101 may send the M1 report to the TCE 110.

The CU-UP may report the total RAN delay, the minimum RAN delay and embodiments related to MDT results.

Step 205 may be described as the network node 101 may provide the information associated with the executed one or more beam measurements to the TCE 110.

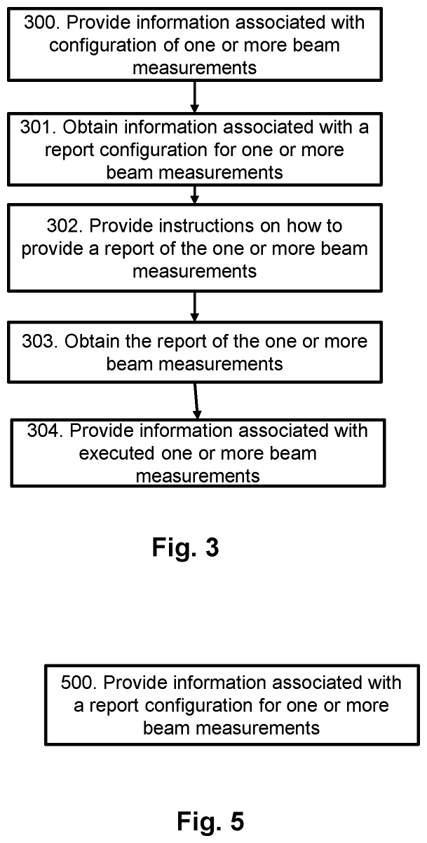

The method described above will now be described seen from the perspective of the network node 101. The network node 101 may be radio access node, a RAN node or any other example of a network node 101 described herein. FIG. 3 is a flowchart describing the present method in the network node 101. The method comprises at least one of the following steps to be performed by the network node 101 which steps may be performed in any suitable order than described below:

Step 300

This step corresponds to step 200 in FIG. 2. The network node 101 may provide, e.g. by direct transmission or via a local memory, central memory, cloud memory etc., to the UE 105 information associated with the beam measurement configuration, i.e. information associated with configuration of the one or more beam measurement.

The information associated with the configuration of the one or more beam measurement provided to the UE 105 may comprises one or more cell quality derivation parameters.

The cell quality derivation parameters may indicate a set of parameters to which the UE 105 is configured to derive specific cell and beam measurements used for the derivation of cell measurement results.

Step 301

This step corresponds to step 201 in FIG. 2. The network node 101 may obtain, e.g. by direct reception or via a local memory, central memory, cloud memory etc., information associated with beam measurement configuration from another node 113, 115, i.e. information associated with a report configuration for one or more beam measurements.

The other node may be e.g. an OAM node 113 or OAM function implemented in a node 113 or a core network node 115.

The beam measurement configuration may be a M1 measurement configuration.

The report configuration may be a MDT measurement report.

Step 302

This step corresponds to step 202 in FIG. 2. The network node 202 may provide, e.g. by direct transmission or via a local memory, system memory, cloud memory etc., to a UE 105, instructions on how to provide information associated with one or more beam measurements to the network node 101, i.e. instructions on how to provide a report of the one or more beam measurements to the network node 101. The instructions may be provided based on based on the information obtained in step 301.

The instructions on how to provide information, i.e. to provide the report of the one or more beam measurements, may comprise reportConfig parameters or is comprised in the reportConfig parameters. This step may be described as the network node 101 forwards the related reoprtConfig parameters to the UE 105.

Step 303

This step corresponds to step 203 in FIG. 2. The network node 101 may obtain, e.g. by direct reception or via a local memory, system memory, cloud memory etc., information associated with one or more beam measurements from the UE 105. i.e. the report of the one or more beam measurement. The information, i.e. the report, may be obtained according to the provided instructions.

The report comprises information associated with executed one or more beam measurements. The report is obtained based on the instructions in step 302, i.e. the UE 105 has provided the report to the network node 101 as instructed by the network node 101 in step 302.

The beam measurements may be M1 beam measurements.

Step 303 may be described as the network node 101 obtains the measurement report from the UE 105, which may comprise the measurements including the beam level measurements. The measurements may also include cell measurements.

Step 304

This step corresponds to step 204 and 205 in FIG. 2. The network node 101 may provide, e.g. by direct transmission or via a local memory, system memory, cloud memory etc., information associated with the executed one or more beam measurements to a TCE 110.

The one or more cell quality derivation parameters may be provided to the TCE 110 together with the information associated with the executed one or more beam measurements, and together with information associated with cell measurement results.

The information associated with the executed one or more beam measurements may be an M1 report or comprised in an M1 report.

The information associated with the executed one or more beam measurements may be comprised in a measurement report.

Step 304 may be described as the network node 101 appends information associated with the executed one or more beam measurements, e.g. absThreshSS-BlocksConsolidation and nrofSS-BlocksToAverage, to a report and provides the report to the TCE. This allows the TCE receiving the report to deduce the configuration parameters according to which the beam level measurements were derived. Note that the UE may include this information in step 303, as configured by the network node 101 in the instructions.

The measurement report may be an MDT measurement report.

The information associated with a beam measurement configuration may comprise one or more cell quality derivation parameters.

The cell quality derivation parameters may indicate a set of parameters to which the UE 105 is configured to derive specific cell and beam measurements used for the derivation of cell measurement results.

The information associated with a beam measurement configuration may be a measObject or comprised in a measObject message or comprised in measObject information.

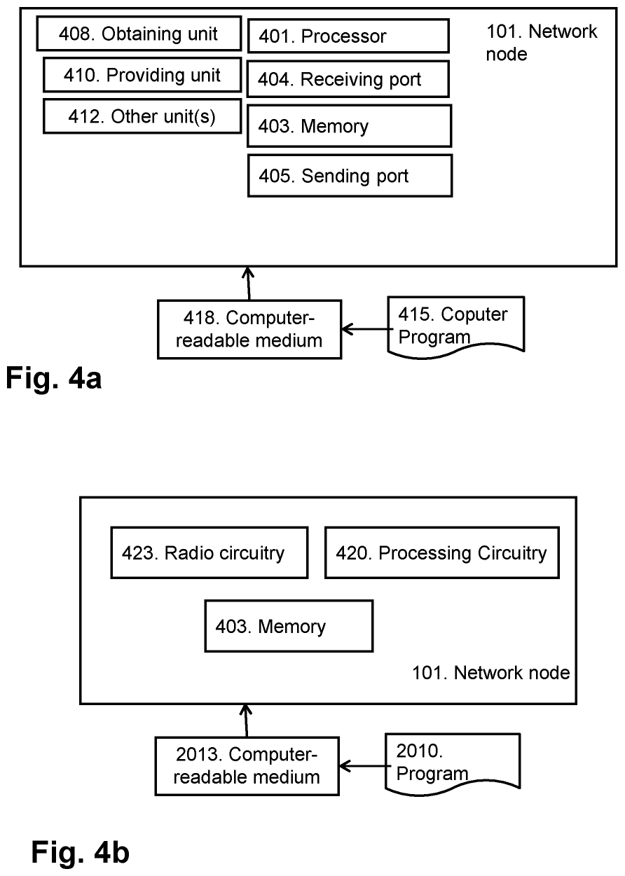

To perform the method steps shown in in FIG. 3, the network node 101 for handling of one or more beam measurements in a communications system 100 may comprise an arrangement as shown in FIG. 4a and/or FIG. 4b, which will be described in more detail below. The network node 101 is adapted to perform a method as illustrated in e.g. FIGS. 2 and 3. The network node 101 may be a radio access node 101.

The network node 101 is adapted to obtain, e.g. by means of an obtaining unit 408, information associated with a report configuration for one or more beam measurement from another node 113, 115. The report configuration may be an MDT measurement report. The other node 113, 115 may be an OAM node 113 or an OAM function implemented in a node 113 or a core network node 115.

The network node 101 is adapted to, e.g. by means of a providing unit 410, based on the obtained information, provide, to a UE 105, instructions on how to provide a report of the one or more beam measurements to the network node 101. The instructions on how to provide the report of the one or more beam measurement may comprise reportConfig parameters or is comprised in the reportConfig parameters.

The network node 101 is adapted to obtain, e.g. by means of the obtaining unit 408, from the UE 105 and according to the instructions, the report of the one or more beam measurement. The report comprises information associated with executed one or more beam measurements.

The network node 101 may be adapted to, e.g. by means of the providing unit 410, provide the information associated with the executed one or more beam measurements to a TCE 110. One or more cell quality derivation parameters may be provided to the TCE 110 together with the information associated with the executed one or more beam measurements, and together with information associated with cell measurement results.

The network node 101 may be adapted to, e.g. by means of the providing unit 410, provide, to the UE 105, information associated with configuration of the one or more beam measurement. The information associated with the configuration of the one or more beam measurement provided to the UE 105 may comprise one or more cell quality derivation parameters. The cell quality derivation parameters may indicate a set of parameters to which the UE 105 is configured to derive specific cell and beam measurements used for the derivation of cell measurement results.

A computer program may comprise instructions which, when executed on at least one processor, cause the at least one processor to carry out the method as described herein. A carrier may comprise the computer program, and the carrier may be one of an electronic signal, optical signal, radio signal or computer readable storage medium.

The method described above will now be described seen from the perspective of the OAM node 113. FIG. 5 is a flowchart describing the present method for handling one or more beam measurements in a communications system 100 in the OAM node 113. Note that the OAM 113 is used as an example in FIG. 5, and that the method may equally be performed by a core network node 115. Using other words, the method illustrated in FIG. 5 may be performed by a node 113, 115, and the node 113, 115 may be an OAM node 113 or a core network node 115. The method comprises at least one of the following steps to be performed by the OAM node 113 which steps may be performed in any suitable order than described below:

Step 500

This step corresponds to step 201 in FIG. 2. The OAM node 113 provides information associated with beam measurement configuration to a network node 101, i.e. it provides information associated with a report configuration for one or more beam measurements to a network node 101.

To perform the method steps shown in in FIG. 5, the node 113, 115, herein exemplified by the OAM 113, may comprise an arrangement as shown in FIG. 4a and/or FIG. 4b, which will be described in more detail below. The node 113, 115 may be an OAM node 113 or an OAM function implemented in a node 113 or a core network node 115. The network node 113, 115, e.g. the OAM 113, for handling one or more beam measurements in a communications system 100 is adapted to perform a method as illustrated in e.g. FIGS. 2 and 5.

The node 113, 115 is adapted to, e.g. by means of the providing unit 410, provide information associated with a report configuration for one or more beam measurements to a network node 101.

A computer program may comprise instructions which, when executed on at least one processor, cause the at least one processor to carry out the method as described herein. A carrier may comprise the computer program, and the carrier may be one of an electronic signal, optical signal, radio signal or computer readable storage medium.

FIG. 4a and FIG. 4b mentioned above will now be described in more detail. FIGS. 4a and 4b depict two different examples in panels a) and b), respectively, of the arrangement that the network node 101 may comprise. The arrangements shown in FIG. 4a and FIG. 4b may, instead of being comprised in the network node 101, be comprised in the OAM 113, the core network node 115 or the TCE 110. The network node 101 will be used in the following description for the sake of simplicity. The network node 101 may comprise the following arrangement depicted in FIG. 4a.

The present disclosure associated with the network node 101 may be implemented through one or more processors, such as a processor 401 in the network node 101 depicted in FIG. 4a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 403 comprising one or more memory units. The memory 403 is arranged to be used to store obtained information, store data, configurations, schedulings, and applications etc. to perform the methods herein when being executed in the network node 101.

The network node 101 may receive information from, e.g., the UE 105, through a receiving port 404. The receiving port 404 may be, for example, connected to one or more antennas in network node 101. The network node 101 may receive information from another structure in the communications system 100 through the receiving port 404. Since the receiving port 404 may be in communication with the processor 401, the receiving port 404 may then send the received information to the processor 401. The receiving port 404 may also be configured to receive other information.

The processor 401 in the network node 101 may be configured to transmit or send information to e.g., the UE 105, or another structure in the communications system 100, through a sending port 405, which may be in communication with the processor 401, and the memory 403.

The network node 101 may comprise an obtaining unit 408, a providing unit 410, and other unit(s) 412.

Those skilled in the art will also appreciate that the obtaining unit 408, a providing unit 410, and other unit(s) 412 etc. described above may refer to a combination of analog and digital circuits, and/or one or more processors configured with software and/or firmware, e.g., stored in memory, that, when executed by the one or more processors such as the processor 401, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 408-412 described above may be implemented as one or more applications running on one or more processors such as the processor 401.

Thus, the methods described herein for the network node 101 may be respectively implemented by means of a computer program 415 product, comprising instructions, i.e., software code portions, which, when executed on at least one processor 401, cause the at least one processor 401 to carry out the actions described herein, as performed by the network node 101. The computer program 415 product may be stored on a computer-readable storage medium 418. The computer-readable storage medium 418, having stored thereon the computer program 415, may comprise instructions which, when executed on at least one processor 401, cause the at least one processor 401 to carry out the actions described herein, as performed by the network node 101. The computer-readable storage medium 418 may be a non-transitory computer-readable storage medium, such as a CD ROM disc, or a memory stick. The computer program 415 product may be stored on a carrier containing the computer program 415 just described, wherein the carrier is one of an electronic signal, optical signal, radio signal, or the second computer-readable storage medium 418, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 4b. The network node 101 may comprise a processing circuitry 420, e.g., one or more processors such as the processor 401, in the network node 101 and the memory 403. The network node 101 may also comprise a radio circuitry 423, which may comprise e.g., the receiving port 404 and the sending port 405. The processing circuitry 420 may be configured to, or operable to, perform the method actions according to FIGS. 2. 3 and 5 in a similar manner as that described in relation to FIG. 4a. The radio circuitry 423 may be configured to set up and maintain at least a wireless connection with the network node 101. Circuitry may be understood herein as a hardware component.

The network node 101 may be operative to operate in the communications system 100. The network node 101 may comprise the processing circuitry 420 and the memory 403. The memory 403 comprises instructions executable by the processing circuitry 420. The network node 101 is operative to perform the actions described herein in relation to the network node 101, e.g. in FIGS. 2, 3 and/or 5.

Further Extensions and Variations

A telecommunication network may be connected via an intermediate network to a host computer.

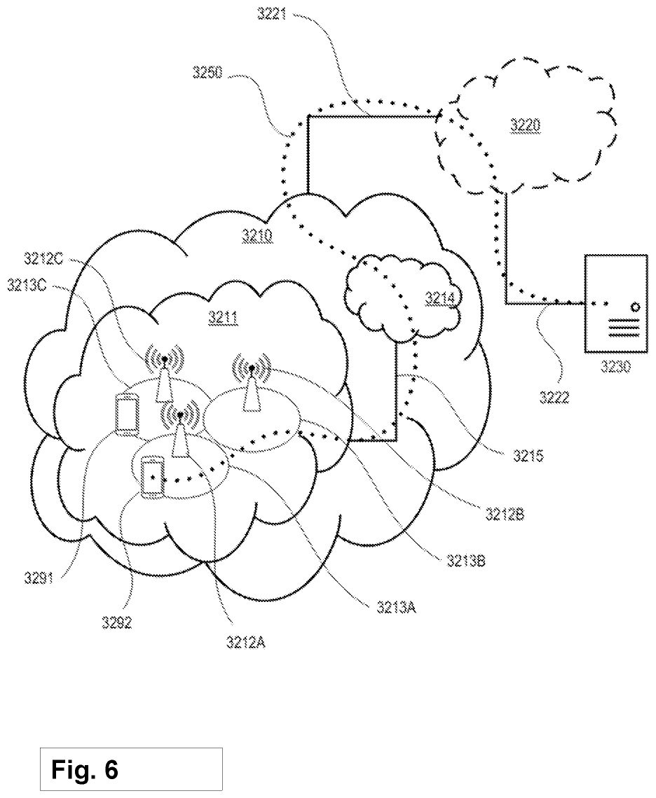

With reference to FIG. 6, a communication system comprises telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 6, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 6 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

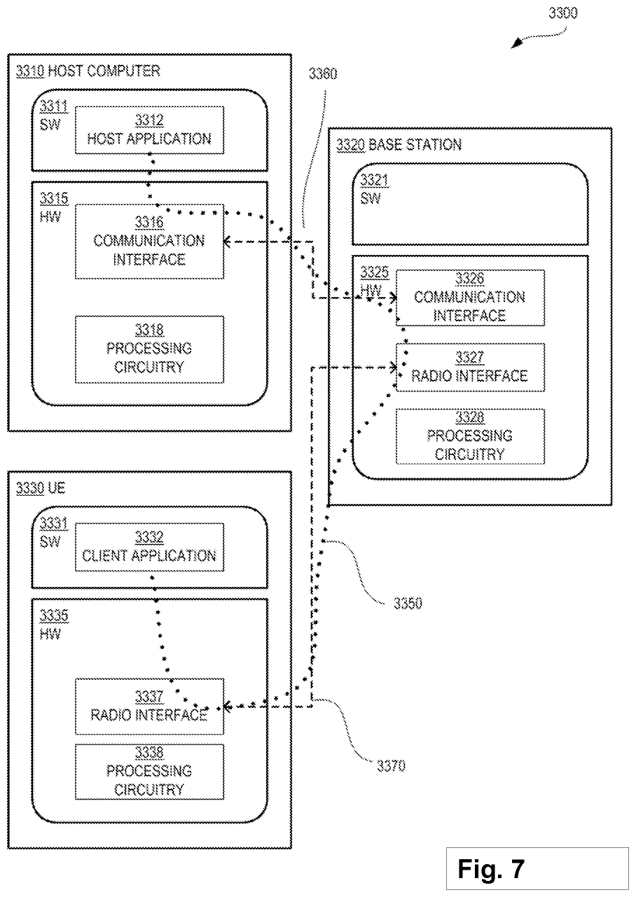

In relation to FIGS. 7-11 which are described next, it may be understood that the base station may be considered an example of the network node 101.

FIG. 7 illustrates an example of host computer communicating via a network node 101 with a UE 105 over a partially wireless connection.

The UE 105 and the network node 101, e.g., a base station and host computer discussed in the preceding paragraphs will now be described with reference to FIG. 7. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 7 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 7 as a UE 3330 located in a coverage area served by base station 3320. Communication interface 3326 may be configured to facilitate connection 3360 to host computer 3310. Connection 3360 may be direct, or it may pass through a core network (not shown in FIG. 7) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 320, respectively. This is to say, the inner workings of these entities may be as shown in FIG. 7 and independently, the surrounding network topology may be that of FIG. 6.

In FIG. 7, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g. based on load balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or dummy messages, using OTT connection 3350 while it monitors propagation times, errors etc.

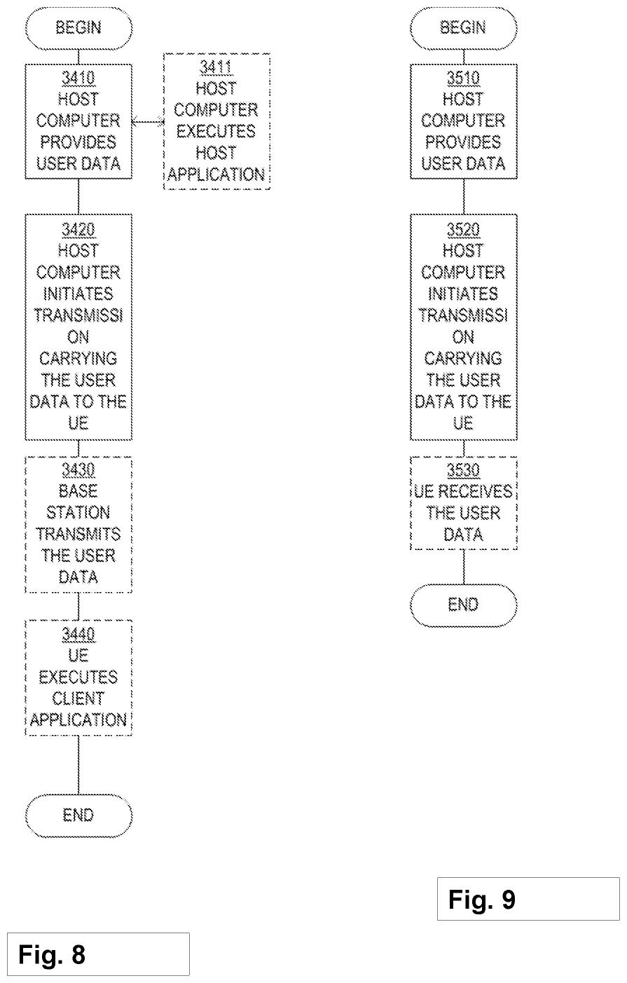

FIG. 8 illustrates an example of methods implemented in a communication system comprising a host computer, a base station and a UE 105. FIG. 8 is a flowchart illustrating a method implemented in a communication system. The communication system comprises a host computer, a base station and a UE 105 which may be those described with reference to FIG. 6 and FIG. 7. For simplicity of the present disclosure, only drawing references to FIG. 8 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may also be optional), the UE executes a client application associated with the host application executed by the host computer.

FIG. 9 illustrates methods implemented in a communication system comprising a host computer, a base station and a UE 105. FIG. 350 is a flowchart illustrating a method implemented in a communication system. The communication system comprises a host computer, a base station and a UE 105 which may be those described with reference to FIG. 6 and FIG. 7. For simplicity of the present disclosure, only drawing references to FIG. 9 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

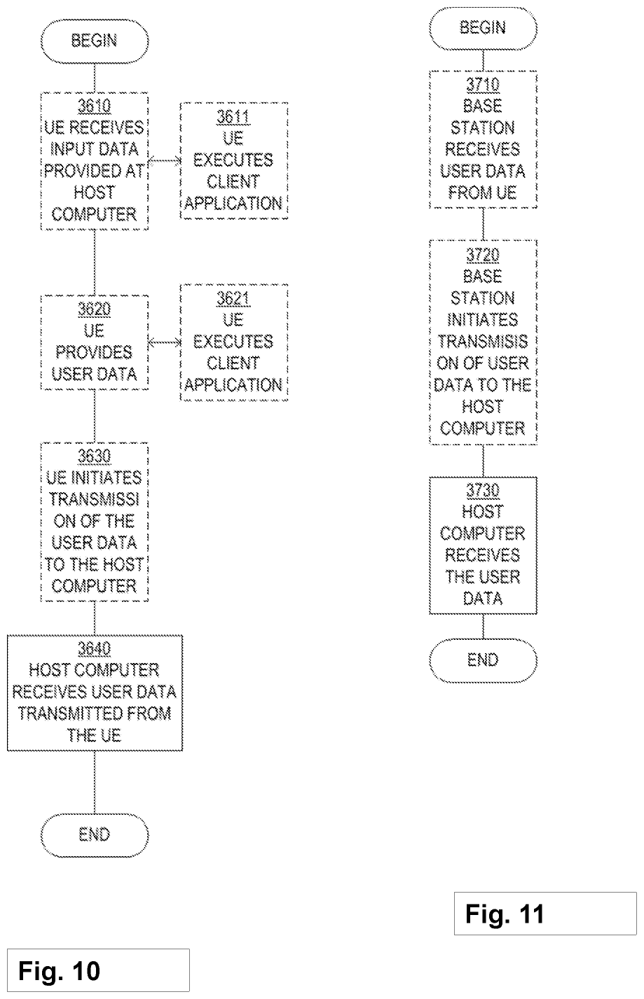

FIG. 10 illustrates methods implemented in a communication system comprising a host computer, a base station and a UE 105. FIG. 10 is a flowchart illustrating a method implemented in a communication system. The communication system comprises a host computer, a network node 101 and a UE 105 which may be those described with reference to FIG. 6 and FIG. 7. For simplicity of the present disclosure, only drawing references to FIG. 10 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 11 illustrates methods implemented in a communication system comprising a host computer, a base station and a UE 105. FIG. 11 is a flowchart illustrating a method implemented in a communication system. The communication system comprises a host computer, a base station and a UE 105 which may be those described with reference to FIG. 6 and FIG. 7. For simplicity of the present disclosure, only drawing references to FIG. 11 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the

UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

The present disclosure relates to a beam related configuration for UE measurement collection.

The present disclosure starts from the assumption that a MeasObject has already provided to the UE in the beam measurement configuration, e.g. cell quality derivation parameters. In general, this is the assumption for M1 measurements, i.e. the M1 measurement configuration is not provided by OAM via MDT Configuration but it is provided by the RAN. According to the current specifications, the M1 configuration sent from the OAM only addresses the reportConfig related parameters, and not the measObject parts.

The present disclosure does not imply any changes at specification level concerning the RRC protocol used to configure the UE with measurement reports, as the only addition is for UE to report as part of MDT measurements also the beam measurements and for the RAN or the UE to report the cell quality derivation parameters.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a network node for handling of one or more beam measurements in a communications system, the method comprising:
obtaining information associated with a report configuration for one or more beam measurements from another node;
based on the obtained information, providing, to a User Equipment, UE, instructions on how to provide a report of the one or more beam measurements to the network node; and
obtaining, from the UE and according to the instructions, the report of the one or more beam measurement, the report comprising information associated with executed one or more beam measurements.

2. The method according to claim 1, comprising:
providing the information associated with the executed one or more beam measurements to a Trace Collection Entity, TCE.

3. The method according claim 1, wherein the instructions on how to provide the report of the one or more beam measurement comprises reportConfig parameters or is comprised in the reportConfig parameters.

4. The method according to claim 1, comprising:
providing, to the UE, information associated with configuration of the one or more beam measurement.

5. The method according to claim 1, wherein the report configuration is a Minimization of Drive Tests, MDT, measurement report.

6. The method according to claim 4, wherein the information associated with the configuration of the one or more beam measurement provided to the UE comprises one or more cell quality derivation parameters.

7. The method according to claim 6, wherein the one or more cell quality derivation parameters indicate a set of parameters to which the UE is configured to derive specific cell and beam measurements used for the derivation of cell measurement results.

8. The method according to claim 6, wherein the one or more cell quality derivation parameters are provided to the TCE together with the information associated with the executed one or more beam measurements, and together with information associated with cell measurement results.

9. The method according to claim 1, wherein the network node is a Radio Access node.

10. The method according to claim 1, wherein the other node is an Operation and Maintenance, OAM, node or an OAM function implemented in a node or a core network node.

11. A network node for handling reporting of one or more beam measurements in a communications system, the network node configured to:
obtain information associated with a report configuration for one or more beam measurements from another node;
based on the obtained information, provide, to a User Equipment, UE, instructions on how to provide a report of the one or more beam measurements to the network node; and
obtain, from the UE and according to the instructions, the report of the one or more beam measurement, the report comprising information associated with executed one or more beam measurements.

12. (canceled)

13. (canceled)

14. A method performed by a node for handling one or more beam measurements in a communications system, the method comprising:
providing information associated with a report configuration for one or more beam measurements to a network node.

15. The method according to claim 14, wherein the node is an Operation and Maintenance, OAM, node or an OAM function implemented in a node or a core network node.

16. An Operation and Maintenance, OAM, node in a communications system, the OAM node configured to:
provide information associated with a report configuration for one or more beam measurements to a network node.

17. (canceled)

18. (canceled)

19. The method according to claim 2, wherein the instructions on how to provide the report of the one or more beam measurement comprises reportConfig parameters or is comprised in the reportConfig parameters.

20. The method according to claim 2, comprising:
providing, to the UE, information associated with configuration of the one or more beam measurement.

21. The method according to claim 20, wherein the information associated with the configuration of the one or more beam measurement provided to the UE comprises one or more cell quality derivation parameters.

22. The method according to claim 21, wherein the one or more cell quality derivation parameters indicate a set of parameters to which the UE is configured to derive specific cell and beam measurements used for the derivation of cell measurement results.

23. The method according to claim 21, wherein the one or more cell quality derivation parameters are provided to the TCE together with the information associated with the executed one or more beam measurements, and together with information associated with cell measurement results.

24. The method according to claim 2, wherein the report configuration is a Minimization of Drive Tests, MDT, measurement report.
